(19) United States
(12) Patent Application Publication
(10) Pub. No.: US 2024/0416496 A1
(43) Pub. Date: Dec. 19, 2024

(54) GRIP FOR POWER TOOL

(71) Applicant: AIMSAK CO., LTD., Cheongju-si, Chungcheongbuk-do (KR)

(72) Inventor: Hyun Cheol LEE, Cheongju-si (KR)

(73) Assignee: AIMSAK CO., LTD., Cheongju-si, Chungcheongbuk-do (KR)

(21) Appl. No.: 18/703,789

(22) PCT Filed: Nov. 17, 2022
(86) PCT No.: PCT/KR2022/018206

§ 371 Date: Apr. 23, 2024

(30) Foreign Application Priority Data
Nov. 19, 2021 (KR) 10-2021-0160496

(51) Int. Cl. B25F 5/00

(52) U.S. Cl. CPC B25F 5/006

(57) ABSTRACT

The present invention provides a grip for a power tool, which is formed on the handle of the power tool, comprising: a first grip formed on the back of the handle to be gripped by the palm of a worker; and a second grip formed on the front of the handle to be gripped by the fingers of the worker, wherein the first grip comprises a cushion portion having a space accommodating the air toward the inside of the handle so as to provide elasticity when being gripped by the worker.

### TECHNICAL FIELD

The present disclosure relates to a grip for a power tool and, particularly, to a grip for a power tool that can improve work efficiency of a power tool by attenuating fatigue of a worker's hand that easily becomes tired due to vibration or shock, which is generated when the power tool is operated, and by improving a grip sense.

### BACKGROUND ART

Power tool is configured in a structure in which a motor that is operated by power supplied from a battery or the outside is mounted in a case and various tools such as a drill, a driver, a grinder, or a circular saw are mounted in a tool mount socket extending from the rotary shaft of the motor.

Since power tool is operated by using the power of a motor, the work efficiency is very excellent in comparison to manual tool. Accordingly, recently, even ordinary households increasingly purchase and use power tool.

Power tool has many advantages, but has a defect as well in that vibration and shock are continuously generated by a motor and a tool that are rotated in operation and, accordingly, the shock is easily transmitted to the hand of a worker who holds the power tool and the hand easily becomes fatigued. A worker has to rest when his or her hand becomes fatigued, so work efficiency is unavoidably deteriorated unless shock by a power tool is effectively attenuated.

Further, when the force that holds a power tool decreases, the danger of dropping of the power tool from a hand increases, so a safety problem may be generated. In jobs that use power tool for a long time, use of a power tool may be a factor that causes chronic diseases of the muscles and joints of a hand. Because of this matter, a lot of effort to not only improve the performance of power tool but also to implement an ergonomic design that enables workers to easily use power tool is being made.

As a related art, Patent Document 1 describes a technology of improving the rubber grip that is disposed on the handle of a power tool to be able to suppress a raise in the degree of fatigue of a hand due to shock and vibration that are generated when a power tool is operated and to improve a grip sense when holding the handle. In detail, Patent Document 1 describes a shock attenuation grip for a power tool that is configured such that a plurality of uneven projection lines inclined downward on the surface of a grip elastically supports the finger of a worker holding the power tool.

Referring to FIG. 1, in the grip for a power tool of Patent Document 1, a plurality of uneven projection lines inclined downward with respect to the main axis X of a power tool are continuously formed to be spaced apart from each other on the surface of a grip 10. However, there is a problem in that it is impossible to secure the efficiency of fingers for holding the grip of a handle using only a plurality of uneven projection lines.

### PRIOR ART DOCUMENT

(Patent Document 1) Korean Patent Application Publication No. 10-2017-0064238 (publication date: 2017.06.09)

### DETAILED DESCRIPTION OF INVENTION

### Technical Problems

The present disclosure has been made in an effort to solve the problems of the related art described above and an objective of the present disclosure is to provide a grip for a power tool that can secure durability of a cushion portion formed at the grip to attenuate vibration and shock.

Further, an objective of the present disclosure is to provide a grip for a power tool that can secure the efficiency of fingers for holding the grip on the handle of a power tool.

Further, an objective of the present disclosure is to provide a grip for a power tool that has a cushion portion to be able to maximize attenuation of vibration and shock.

### Technical Solution

In order to achieve the objectives described above, a grip for a power tool according to an embodiment of the present disclosure includes: a first grip formed on a rear of a handle to be held by the palm of a worker; and a second grip formed on a front of the handle to be held by the fingers of a worker. The first grip may include a cushion portion that has a space that keeps air toward the inside of the handle and provides elasticity with a worker holding the cushion portion.

The cushion portion of the first grip may include frame forming a framework and air storage keeping air.

The air storage may be formed in an arch shape or a semispherical shape.

Hole for airflow toward the inside of the handle may be formed at the air storage of the cushion portion of the first grip.

When the first grip is pressed with a worker holding the handle, air in the air storage may flow toward the inside of the handle.

When pressure applied to the first grip is decreased or removed, air in the inside of the handle may flow into the air storage.

The first grip may include a first upper grip that is held by a palm between the thumb and the index finger of a worker.

The first grip may include a first lower grip that is held by a palm part at which the middle finger, the ring finger, and the little finger of a worker are positioned.

A plurality of projection lines protruding downward at an angle with respect to the direction of a main axis of a power tool may be formed to be spaced apart from each other on the surface of the second grip.

The projection lines formed on the surface of the second grip may be formed such that a center portion that is held by the ring finger of a worker protrudes relatively less to be concave toward the inside of the handle in comparison to the other adjacent portions.

### Effect of Invention

The grip for a power tool according to the present disclosure that has the configuration described above has an effect that an arch-shaped or semispherical cushion portion is formed on the rear of a handle, so it is possible to secure durability.

Further, the grip for a power tool according to the present disclosure has an effect that a plurality of projection lines is formed in a wave shape on the front of the handle, so it is possible to secure holding efficiency of fingers.

Further, the grip for a power tool according to the present disclosure has an effect that an arch-shaped or semispherical cushion portion is formed at the upper portion and the lower portion of the rear of the handle of a power tool and a plurality of projection lines is formed on the front of the handle, so it is possible to maximize attenuation of vibration and shock that are generated at the grip of the handle of a power tool.

### BRIEF DESCRIPTION OF THE DRAWING

FIG. 1 is a view showing a grip for a power tool according to the related art.

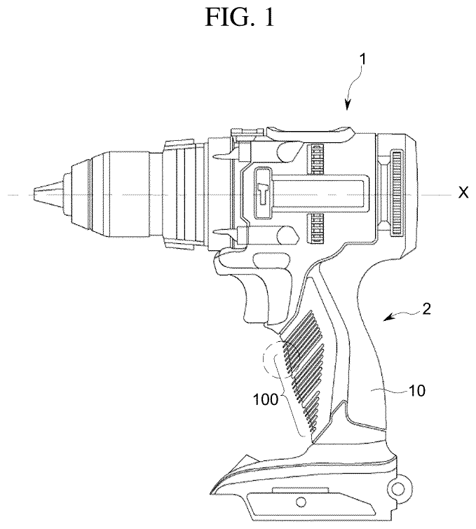

FIG. 2 is a view showing a power tool to which a grip for a power tool according to an embodiment of the present disclosure has been applied.

FIG. 3 is a view showing a vertical cross-section of a handle to show the structure of the grip for a power tool according to an embodiment of the present disclosure and showing a hand of a worker holding the handle.

FIG. 4 is an enlarged view showing a vertical cross-section of a handle to show the structure of the grip for a power tool according to an embodiment of the present disclosure.

### BEST MODE FOR CARRYING OUT THE INVENTION

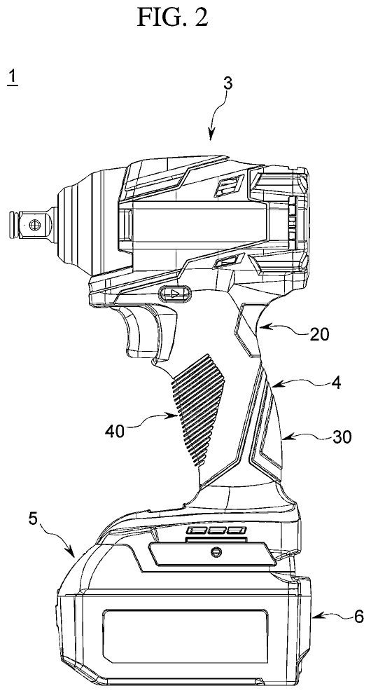

Hereafter, a grip for a power tool according to the present disclosure is described in detail with reference to FIGS. 2 to 4.

FIG. 2 is a view showing a power tool to which a grip for a power tool according to an embodiment of the present disclosure has been applied. A grip for a power tool according to the present disclosure is described in detail with reference to FIG. 2.

A power tool 1 according to an embodiment of the present disclosure includes a body 3 in which a motor is mounted and that is equipped with various tools such as a drill, a driver, and a grinder, a handle 4 positioned under the body 3, a battery coupling part 5 disposed under the handle 4, and a battery 6 mounted on the bottom of the battery coupling part 5 and supplying power to the motor.

First grips 20 and 30 that are held by the palm of a worker are formed on the rear of the handle 4 of the power tool 1 and a second grip 40 formed to be held by the fingers of a worker is formed on the front of the handle 4.

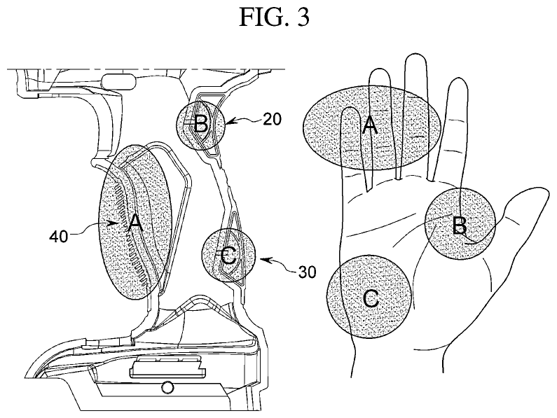

FIG. 3 is a view showing a vertical cross-section of a handle to show the structure of the grip for a power tool according to the embodiment of the present disclosure and showing the hand of a worker holding the handle.

Referring to FIG. 3, the first grips 20 and 30 may include a first upper grip 20 that is held by the part B that is the palm part between the thumb and the index finger of a worker. Further, the first grips 20 and 30 may include a first lower grip 30 that is held by the part C that is the palm part at which the middle finger, the ring finger, and the little finger of a worker are positioned.

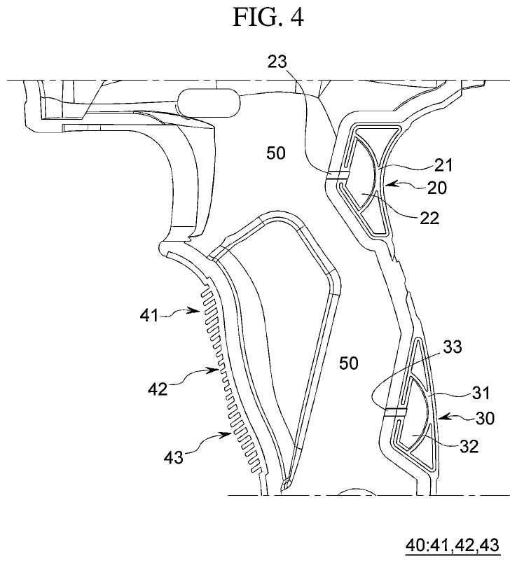

FIG. 4 is an enlarged view showing a vertical cross-section of a handle to show the structure of the grip for a power tool according to the embodiment of the present disclosure.

Referring to FIG. 4, a cushion portion that has a space keeping air toward the inside 50 of the handle and provides elasticity with a worker holding the cushion portion is formed at the first grips 20 and 30.

The first upper grip 20 at which the cushion portion is formed is held by the palm part between the thumb and the index finger of a worker and can attenuate vibration and shock that are generated when working. The first lower grip 30 is tightly held by the palm part at which the middle finger, the ring finger, and the little finger of a worker are positioned, and can attenuate vibration and shock that are generated when working.

The cushion portion of the first grips 20 and 30 has air storages 22 and 32 formed in an arch shape or a semispherical shape at the portion to which pressure is applied when working, and air is kept in the air storages. The air storages 22 and 32 may be formed by frames 21 and 31 forming the framework. The frames 21 and 31 may be made of an elastic material to provide elasticity. Since the cushion portion composed of the arch-shaped or semispherical air storages 22 and 32 and the frames 21 and 31 are formed at the first grips 20 and 30, durability of the first grips 20 and 30 to which vibration and shock are repeatedly applied can be improved.

The air storages 22 and 32 have holes 23 and 33 formed at first ends thereof and enabling airflow toward the inside 50 of the handle. When the first grips 20 and 30 are pressed by vibration or shock with a worker holding the handle, the vibration or the shock is absorbed and attenuated by elasticity of the cushion portion composed of the frames 21 and 32 and the air storages 22 and 32. In this case, excessive pressure is applied, some of the air in the air storages 22 and 32 flows toward the inside 50 of the handle by pressure, whereby appropriate elasticity can be maintained. When pressure applied to the first grips 20 and 30 is decreased or removed, some of the air in the inside 50 of the handle flows into the air storages 22 and 32, whereby the cushion portion can be deformed to return into the shape before it is pressed.

Meanwhile, a plurality of projection lines protruding downward at an angle with respect to the direction of the main axis of a power tool are spaced apart from each other on the surface of the second grip 40 to attenuate shock that is applied to the part that is held by the fingers. The plurality of projection lines is made of an elastic material and provides elasticity.

The projection lines formed on the surface of the second grip 40 are formed such that the center portion 42 that is held by the ring finger of a worker protrudes relatively less to be concave toward the inside 50 of the handle in comparison to the other adjacent portions 41 and 43. Waved projection lines are formed the second grip 40 in this way, whereby it is possible to secure holding efficiency of fingers.

The first grips 20 and 30 can be divided into an upper section and a lower section that are two parts that are pressed by the palm of a worker. That is, the first grips 20 and 30 include the first upper grip 20 and the first lower grip 30. Since the arch-shaped or semispherical cushion portion is applied to the first grips 20 and 30 and a plurality of projection lines is formed in a wave shape on the second grip 40, it is possible to maximize attenuation of vibration and shock that are applied to the grip of the handle.

The above description merely explains the spirit of the present disclosure and the present disclosure may be changed, modified, and replaced in various ways without departing from the spirit of the present disclosure by those skilled in the art. Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the range of right of the present disclosure.

[DESCRIPTION OF REFERENCE NUMERALS]

| | |
|---|---|
| 1: grip of power tool | 21, 31: frame |
| 3: body | 22, 32: air storage |
| 4: handle | 23, 33: hole |
| 5: battery coupling part | 30: first lower grip |
| 6: battery | 40: second grip |
| 20: first upper grip | 50: inside of handle |

What is claimed is:

1. A grip for a power tool that is formed on the handle of a power tool, the grip comprising:
a first grip formed on the rear of the handle to be held by the palm of a worker; and
a second grip formed on the front of the handle to be held by the fingers of a worker,
wherein the first grip comprises a cushion portion that has a space keeping air toward the inside of the handle and provides elasticity with a worker holding the cushion portion.

2. The grip for the power tool of claim 1, wherein the cushion portion of the first grip comprises frame forming a framework and air storage keeping air.

3. The grip for the power tool of claim 2, wherein the air storage is formed in an arch shape or a semispherical shape.

4. The grip for the power tool of claim 3, wherein a hole for airflow toward the inside of the handle is formed at the air storage of the cushion portion of the first grip.

5. The grip for the power tool of claim 4, wherein when the first grip is pressed with a worker holding the handle, air in the air storage flows toward the inside of the handle.

6. The grip for the power tool of claim 5, wherein when pressure applied to the first grip is decreased or removed, air in the inside of the handle flows into the air storage.

7. The grip for the power tool of claim 1, wherein the first grip includes a first upper grip that is held by a palm between the thumb and the index finger of a worker.

8. The grip for the power tool of claim 2, wherein the first grip includes a first upper grip that is held by a palm between the thumb and the index finger of a worker.

9. The grip for the power tool of claim 1, wherein the first grip comprises a first lower grip that is held by a palm part at which the middle finger, the ring finger, and the little finger of a worker are positioned.

10. The grip for the power tool of claim 2, wherein the first grip comprises a first lower grip that is held by a palm part at which the middle finger, the ring finger, and the little finger of a worker are positioned.

11. The grip for the power tool of claim 1, wherein the first grip comprises:
a first upper grip that is held by a palm between the thumb and the index finger of a worker; and
a first lower grip that is held by a palm part at which the middle finger, the ring finger, and the little finger of the worker are positioned.

12. The grip for the power tool of claim 2, wherein the first grip comprises:
a first upper grip that is held by a palm between the thumb and the index finger of a worker; and
a first lower grip that is held by a palm part at which the middle finger, the ring finger, and the little finger of the worker are positioned.

13. The grip for the power tool of claim 1, wherein a plurality of projection lines protruding downward at an angle with respect to the direction of the main axis of a power tool are formed to be spaced apart from each other on the surface of the second grip.

14. The grip for the power tool of claim 2, wherein a plurality of projection lines protruding downward at an angle with respect to the direction of the main axis of a power tool are formed to be spaced apart from each other on the surface of the second grip.

15. The grip for the power tool of claim 14, wherein the projection lines formed on the surface of the second grip are formed such that a center portion that is held by the ring finger of a worker protrudes relatively less to be concave toward the inside of the handle in comparison to the other adjacent portions.
